(19) United States
(12) Patent Application Publication
(10) Pub. No.: US 2026/0213913 A1
(43) Pub. Date: Jul. 23, 2026

(54) UE CAPABILITY INDICATION AND SELECTION OF SBFD OPERATIONS

(71) Applicant: Charter Communications Operating, LLC, St. Louis, MO (US)

(72) Inventors: Phillip B. Oni, Watertown, NY (US); Dumitru M. lonescu, Poway, CA (US)

(21) Appl. No.: 19/373,037

(22) Filed: Oct. 29, 2025

Related U.S. Application Data
(60) Provisional application No. 63/717,230, filed on Nov. 6, 2024.

(51) Int. Cl. H04L 5/14; H04L 5/00

(52) U.S. Cl. CPC H04L 5/1438; H04L 5/0044

(57) ABSTRACT

First communication management hardware is operative to: establish wireless connectivity between the mobile communication device and a wireless base station; via the wireless connectivity, receive an inquiry requesting a communication configuration supported by the mobile communication device; and produce a reply to the inquiry, the reply including notification that the mobile communication device operates in a sub-band full-duplex operational mode. Second communication management hardware is operative to: receive channel access information from a wireless base station, the channel access information supporting establishment of wireless connectivity between the mobile communication device and the wireless base station via multiple different channel access options; determine a configuration of the mobile communication device; and based on the determined configuration, select a first channel access option amongst the multiple channel access options as indicated by the channel access information to establish the wireless connectivity between the mobile communication device and the wireless base station.

### RELATED APPLICATION

This application claims the benefit of earlier filed U.S. Pat. Application Ser. No. 63/717,230 entitled “SUBBAND FULLDUPLEX (SBFD) UE CAPABILITY INDICATION FOR SBFD OPERATIONS,” (Attorney Docket No. CHTR- 2024-188P), filed on Nov. 6, 2024, the entire teachings of which are incorporated herein by this reference.

### BACKGROUND

Conventional wireless networks typically include one or more wireless base stations or wireless access points to provide mobile communication devices (a.k.a., user equipment) access to a remote network such as the Internet or other target communication servers at remote locations. In certain instances, the wireless networks include many different types of networks and/or components that must collectively work together to provide wireless services.

One conventional type of wireless network is a so-called 5G wireless network. A 5G wireless network typically includes at least one so-called 5G radio access network (RANs) and corresponding 5G core network. A conventional 5G wireless base station may be connected to a 5G core network via an IP (Internet Protocol) network commonly referred to as a backhaul. 5G networks implement dynamic policy to enforce behaviors on user traffic.

It is further noted that user equipment such as mobile communication devices use a conventional RACH (Random Access Channel) process to perform initial access to a respective gNB (such as wireless base station or 5G Radio). The random-access channel supports connectivity between communication devices and respective base stations. For example, when a communication device wants to wirelessly connect to a network for the first time or after a period of inactivity, the communication device wirelessly transmits request communications over the random-access channel to request access to the network. The subsequently established wireless connectivity enables the mobile communication device to communicate with the wireless base station.

### BRIEF DESCRIPTION

This disclosure includes the observation that during a UE's (user equipment such as mobile communication device) registration/attach with the wireless network (a.k.a., wireless base station such as enodeB, gnodeB, etc.), it is desirable that the wireless base station in the wireless network is informed of the UE's capabilities in order to configure the UE (User Equipment) accordingly.

For example, to address the shortcomings of conventional techniques, UE capability information as discussed herein can be configured to include a set of information/parameters used by the UE to inform the network (wireless network and corresponding base station) of its capabilities such as via RRC (Radio Resource Control) signaling mechanism. This allows the wireless network to appropriately configure the UE and provide specific wireless bandwidth resource allocation to the UE based on the informed capabilities—resulting in more accurate scheduling decisions.

In general, the wireless network as discussed herein can be configured to request UE capabilities during the UE registration/attach procedures. The wireless network then stores the unique capability information such that the UE does not need to repeatedly transmit the UE capability information during RRC connection or RRC re-establishment. However, it is noted that the wireless base station and corresponding wireless network can be configured to request the UE to send its capability information as it deemed fit during the RRC connected state.

For UEs with capabilities such as those that support SBFD (Sub-Band Full-Duplex) operations, it is desirable that those SBFD-capable UEs inform the wireless network that they can support certain SBFD operations. As discussed herein, this notification of capability allows the wireless network to configure the UEs with SBFD resources in addition to configuring them with legacy resources. In other words, if the wireless network learns that a respective instance of user equipment supports SBFD, the wireless network is then able to provide SBFD functions to that respective instance of user equipment.

Techniques as discussed herein include novel ways of providing notification of sub-band full-duplex (a.k.a., SBFD) capabilities and novel ways of implementing same in a respective network environment.

For example, a mobile communication device may initially establish wireless connectivity between the mobile communication device and a wireless base station. Via the wireless connectivity, assume that the mobile communication device receives an inquiry from a wireless network (such as from a wireless base station in the wireless network), where the inquiry requests to know a communication configuration supported by the mobile communication device. The mobile communication device produces and transmits a reply to the inquiry over a wireless communication link to the wireless base station in the wireless network. The reply can be configured to include a notification that the mobile communication device operates in a so-called sub-band full-duplex operational mode.

As discussed herein, the sub-band full-duplex operational mode is operative to support simultaneous conveyance of uplink and downlink communications over the wireless connectivity using multiple sub-carrier frequencies of an assigned wireless channel. Producing and transmitting of the reply to the inquiry may include the mobile communication device accessing configuration information associated with the mobile communication device. As previously discussed, the configuration information can be configured to indicate that the mobile communication device operates in the so-called sub-band full-duplex operational mode.

Yet further, the reply generated by the mobile communication device (a.k.a., user equipment) or other suitable entity can be configured to include a data field. In response to detecting that the mobile communication device supports the sub-band full-duplex operational mode as indicated by the configuration information, the mobile communication device can be configured to modify an otherwise default value in the data field to be a non-default value instead. The inclusion of the non-default value in the reply indicates that the mobile communication device supports the sub-band full-duplex operational mode.

In another example, in response to the inquiry from the wireless base station, the mobile communication device can be configured to wirelessly transmit the reply to the wireless base station, where the wireless reply indicates that the mobile communication device is configured to operate in the sub-band full-duplex operational mode. In response to the transmitting of the reply to the wireless base station, the mobile communication device further receives a notification message from the wireless base station indicating allocation of a wireless channel supporting sub-band full-duplex communications. It is further noted that the notification received from the wireless base station can be configured to indicate a first or specific time slot or one or more time slots allocated for use by the mobile communication device, where each of the allocated time slots supports both uplink wireless communications from the mobile communication device to the wireless base station and downlink wireless communications from the wireless base station to the mobile communication device in accordance with SBFD.

Still further, the notification from the wireless base station allocating use of wireless resources can be configured to indicate a first sub-wireless carrier frequency and a second sub-carrier wireless frequency in the allocated wireless channel. The first sub-wireless carrier frequency or carrier frequencies may be allocated for use by the mobile communication device to transmit the uplink wireless communications from the mobile communication device to the wireless base station. The second sub-wireless carrier frequency or frequencies may be allocated for use by the mobile communication device to receive the downlink wireless communications over the wireless connectivity from the wireless base station. Via the first sub-wireless carrier frequency, the mobile communication device wirelessly transmits the uplink wireless communications from the mobile communication device over the wireless connectivity to the wireless base station in each of multiple allocated time slots. Via the second sub-wireless carrier frequency, the mobile communication device wirelessly receives the downlink wireless communications from the wireless base station over the wireless connectivity in each of the multiple allocated time slots. Thus, each allocated time slot and corresponding wireless bandwidth support dual directional or bidirectional communications between the mobile communication device and the wireless base station.

Further examples as discussed herein include the mobile communication device receiving the inquiry during a condition in which the mobile communication device operates in an RRC (Radio Resource Control) connected state.

In another example, in response to the mobile communication device transmitting the reply from the mobile communication device over the wireless connectivity to the wireless base station, the mobile communication device further receives schedule information over the wireless connectivity from the wireless base station, where the schedule information indicates scheduled use of a wireless channel by the mobile communication device. The mobile communication device may receive the allocated wireless channel and schedule information in response to the mobile communication device further requesting use of a wireless communication link via the SBFD mode. Note again that the scheduled use can be configured to support simultaneous uplink and downlink communications over the wireless connectivity.

In another example as discussed herein, the mobile communication device receives channel access information from a wireless base station. The channel access information can be configured to support establishment of wireless connectivity between the mobile communication device and the wireless base station via multiple different channel access options such as a first channel access option supporting SBFD communications and a second channel access option supporting non-SBFD communications. The mobile communication device or other suitable entity can be configured to determine a configuration of the mobile communication device. Based on the determined configuration, the mobile communication device can be configured to select a first channel access option amongst the multiple channel access options as indicated by the channel access information to establish the wireless connectivity between the mobile communication device and the wireless base station.

In accordance with timing as specified by the selected first channel access option, the mobile communication device can be configured to transmit a bandwidth request message from the mobile communication device to the wireless base station to establish and/or use the wireless connectivity. In other words, in one example, even prior to the mobile communication device and the wireless base station completing establishment of wireless connectivity between each other, the mobile communication device can be configured to select implementing the first channel access option, resulting in notification to the wireless base station that the mobile communication device supports the SBFD mode.

In a further example, the transmitted message (including configuration information indicating support of the SBFD mode) from the mobile communication to the wireless base station in accordance with the selected first channel access option may be a message #1 (MSG1) or preamble associated with a multi-step RACH (Random Access Channel), where the mobile communication device requests a wireless communication link via use of the random-access channel. In accordance with use of a respective RACH channel, the transmitted message from the mobile communication device can be configured to include a preamble transmitted in an appropriate frequency in a RACH occasion, which indicates the first channel access option, where the preamble is transmitted by the mobile communication device for subsequent scheduling of communications between the mobile communication device and the wireless base station.

Note further that transmission of the message in accordance with the timing as specified by the first channel access option for support of subsequent resources results in scheduling of communications between the mobile communication device and the wireless base station via sub-band full-duplex communications.

Still further, note that the multiple channel access options supplied to the mobile communication device may include: a first channel access option for establishing the wireless connectivity via use of sub-band full-duplex communications between the mobile communication device and the wireless base station; and a second channel access option for establishing the wireless connectivity via use of non-sub-band full-duplex communications between the mobile communication device and the wireless base station. In other words, in one example, the first channel access option can be configured to indicate timing of a first RACH (Random Access Channel) occasion in a random-access channel to indicate the SBFD mode, where the second channel access option may indicate supporting of only the non-sub-band full-duplex communications.

Further, the first channel access option can be configured to indicate timing of one or more second RACH (Random Access Channel) occasions in the random-access channel, where the first channel access options support the sub-band full-duplex communications. Accordingly, the mobile communication device can be configured to select amongst the different type of channel access options (RACH occasions assigned for SBFD communications or RACH occasions assigned for non-SBFD communications) for subsequent communications between the mobile communication device and the wireless base station. As previously discussed, use of the different RACH occasions as used by the mobile communication device notify the wireless base station of which of the SBFD or non-SBFD mode is supported by the mobile communication device.

It is noted further that the second channel access option may be a fallback option with respect to the first channel access option during a condition in which the second channel access option is unavailable or can't be used for some reason. In other words, if for some reason support for the SBFD communication mode is unavailable (even though the mobile communication device may prefer the SBFD mode), the mobile communication device can be configured to use the channel access option selection supporting the fallback option of non-sub-band full-duplex communications mode.

Techniques as discussed herein are useful over conventional techniques. For example, the one or more implementations of a communication management resource and corresponding SBFD support operations as discussed herein provide better use of supporting a random-access channel shared by multiple different entities in the network. Note that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including a non-transitory computer-readable storage medium or any computer readable storage hardware on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium or computer readable hardware storage such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are directed to a method, system, computer program product, computable readable storage hardware, etc., that supports operations as discussed herein.

One example as discussed herein includes computer readable storage hardware having instructions stored thereon. The instructions, when executed by corresponding computer processor hardware, cause the computer processor hardware (such as one or more co-located or disparately processor devices or hardware) to: establish wireless connectivity between the mobile communication device and a wireless base station; via the wireless connectivity, receive an inquiry at the mobile communication device, the inquiry requesting notification of a communication configuration supported by the mobile communication device; and at the mobile communication device, produce and transmit a wireless reply to the inquiry, the wireless reply including notification that the mobile communication device operates in a sub-band full-duplex operational mode.

Another example includes computer readable storage hardware having instructions stored thereon. The instructions, when executed by corresponding computer processor hardware, cause the computer processor hardware (such as one or more co-located or disparately processor devices or hardware) to: receive channel access information from a wireless base station, the channel access information supporting establishment of wireless connectivity between the mobile communication device and the wireless base station via multiple different selectable channel access options; determine a configuration of the mobile communication device; and based on the determined configuration, select a first channel access option (such as indicating the SBFD mode) amongst the multiple channel access options as indicated by the channel access information to establish the wireless connectivity between the mobile communication device and the wireless base station.

The ordering of the steps above has been added for clarity sake. Note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing notification of user equipment capabilities and use of RACH resources in a network environment. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating configuration information assigned to a respective mobile communication device as discussed herein.

FIG. 2 is an example diagram illustrating user equipment capabilities and corresponding parameters as discussed herein.

FIG. 3A is an example diagram illustrating a user equipment capability inquiry communicated from a wireless network and wireless response communication of capability information transmitted from a mobile communication device to the wireless network as discussed herein.

FIG. 3B is an example timing diagram illustrating implementation of multiple different subcarrier frequencies to support bidirectional communications in the SBFD mode as discussed herein.

FIG. 4 is an example diagram illustrating encapsulation of sub-band full-duplex communication capability information associated with a mobile device as discussed herein.

FIG. 5 is an example diagram illustrating distribution and notification of channel access options to a mobile communication device and implementation of a channel access option via selection by the mobile communication device as discussed herein.

FIG. 6A is an example diagram illustrating distribution and notification of channel access options to a mobile communication device and implementation of a selected channel access option by the mobile communication device to acquire channel resources supporting SBFD as discussed herein.

FIG. 6B is an example timing diagram illustrating implementation of multiple different subcarrier frequencies to support bidirectional communications in the SBFD mode as discussed herein.

FIG. 7 is an example diagram illustrating example computer hardware and software operable to execute operations as discussed herein.

FIG. 8 is an example diagram illustrating a method as discussed herein.

FIG. 9 is an example diagram illustrating a method as discussed herein.

The foregoing and other objects, features, and advantages of the invention will be apparent from the following more particular description of preferred examples herein, as illustrated in the accompanying drawings in which reference characters refer to the same parts throughout the different views. The drawings are not necessarily to scale, with emphasis instead being placed upon illustrating the examples, principles, concepts, etc.

### DETAILED DESCRIPTION

As further discussed herein, when a contention based random access (a.k.a., CBRA) RACH configuration is initiated for an SBFD-aware UE (user equipment aware that it supports so-called SBFD communications), that UE can be configured to select a particular type of RO (a.k.a., RACH Occasion) amongst a first legacy RACH occasion option and additional RACH occasion option depending on the configuration and specified conditions/prioritizations associated with the user equipment. It is noted that if a network is configured to support only legacy-ROs (where the network or wireless station only supports non-SBFD operational mode), then only a single RACH configuration is needed to support that non-SBFD operational mode. However, if both legacy ROs and additional-ROs are configured to select between the SBFD mode and the non-SBFD mode, at least two RACH configurations may be communicated by the wireless network (i.e., wireless access point) to the UEs for random access and establishing a respective wireless communication link. In other words, when the wireless network supports the multiple different RACH options such as at least one RACH option supporting SBFD and at least one other RACH option supporting non-SBFD, the wireless network provides notification of these options to the user equipment.

More specifically, in a given wireless network where SBFD (Sub-Band Full-Duplex) is supported, some UEs attached to the gNB (a.k.a., wireless base station) may support SBFD operation while other UEs may not. While legacy ROs are intended for both SBFD-aware and non-SBFD (legacy) UEs, in one example, the additional ROs supporting the SBFD communications are solely intended for selection by SBFD-aware UEs that support such SBFD communications. In such an instance, the SBFD-aware UEs need to know they have the capability for SBFD operation, while the non-SBFD UEs (which do not support SBFD) should know that their capabilities do not support SBFD operation.

The use of UE capability information (a.k.a., configuration information indicating whether the mobile communication device supports non-SBFD communications and/or SBFD communications) as discussed herein enables both SBFD UEs and non-SBFD UEs in a network environment to be aware of which RACH resources they can and cannot use for initial access or attach, especially, the SBFD-aware UEs knowing they could use either legacy ROs (such as one channel access option) and additional ROs (such as a second channel access option) for random access to attach to the wireless network.

Hence, a solution as discussed herein enables the different instances of user equipment to determine if they support SBFD operations (such as via RRC signaling). The different instances of user equipment then inform the wireless network whether they support SBFD or not.

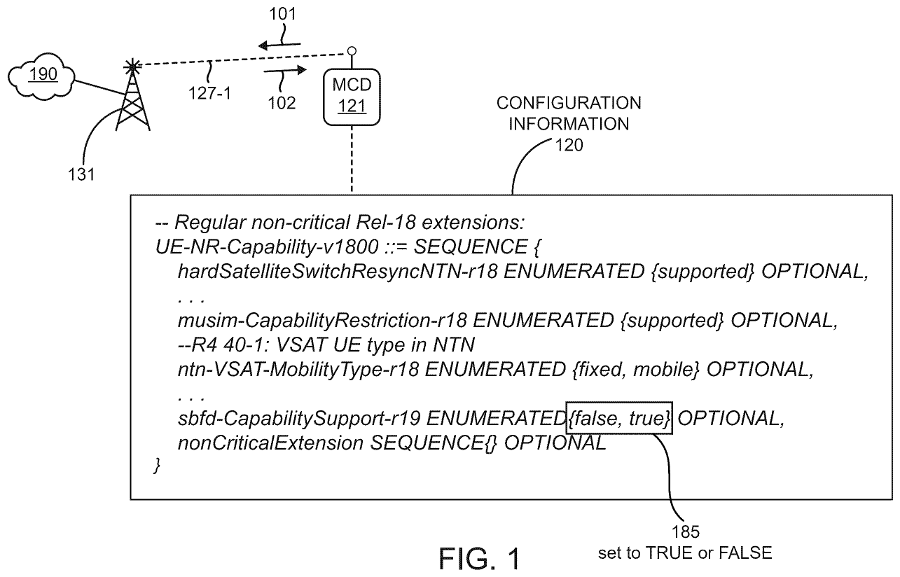

Now, more specifically, with reference to the drawings, FIG. 1 is an example diagram illustrating potential formatting of configuration information assigned to a respective mobile communication device as discussed herein.

In this example, assume that the configuration information 120 and corresponding communication setting 185 indicates that the mobile communication device 121 supports the SBFD mode. In other words, assume that the communication setting 185 is set to true. As previously discussed, the SBFD mode is a mode in which the mobile communication device 121 may be allocated use of wireless resources such as a time slot and multiple subcarrier frequencies that simultaneously support conveyance of uplink and downlink communications.

More specifically, the so-called Sub-Band Full Duplex (SBFD) mode as discussed herein includes implementing a time-division duplex (TDD) carrier frequency split into sub-bands (sub-carrier frequencies), where the split carrier frequencies or sub bands include at least a first sub-band carrier frequency to communicate in an uplink direction from the mobile communication device to the wireless base station and a second sub-band carrier frequency to communicate in a downlink direction from the wireless base station to the mobile communication device. The first sub-band carrier frequency and the second sub-band carrier frequency can be configured to support simultaneous wireless transmission and reception in the same slots. In such an instance, in accordance with simultaneous cross-band scheduling associated with the first sub-band carrier frequency and the second sub-band carrier frequency, the split carrier frequency, time-division duplex (TDD) configuration provides simultaneous guarantees of sufficient uplink throughput and low latency and sufficient downlink throughput and low latency to meet respective communication needs associated with certain applications executed on the mobile communication device or other suitable entity.

Assume in this example that the setting 185 is set to a value of TRUE indicating that the mobile communication device 121 supports the so-called SBFD mode. In such an instance, as further discussed herein, the mobile communication device 121 is able to establish the wireless communication link 127-1 with the wireless base station 131.

Because the setting 185 indicates TRUE, the mobile communication device 121 and the wireless base station 131 can be scheduled to support, in an assigned time slot, simultaneous uplink wireless communications 101 over a first sub-band (first sub-carrier frequency) and downlink wireless communications 102 over a second sub-band (second sub-carrier frequency).

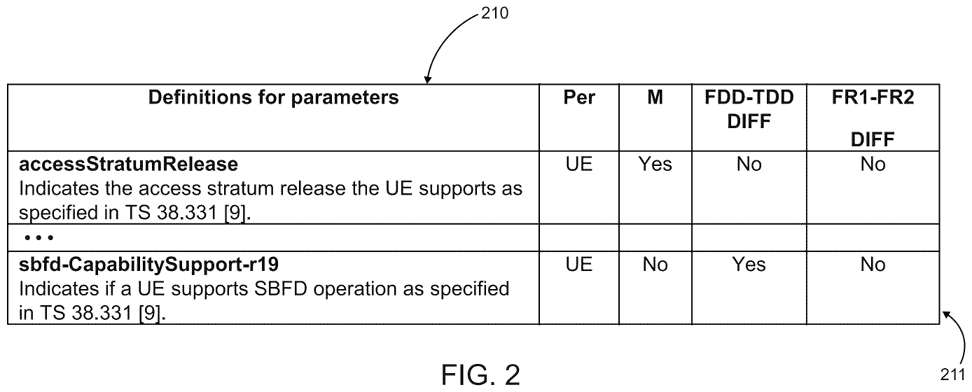

FIG. 2 is an example diagram illustrating user equipment capabilities and parameters as discussed herein.

In this example, the parameter 211 associated with the parameter information 210 indicates user equipment capability parameters indicating support for respective sub-band full-duplex communications associated with the mobile communication device 121.

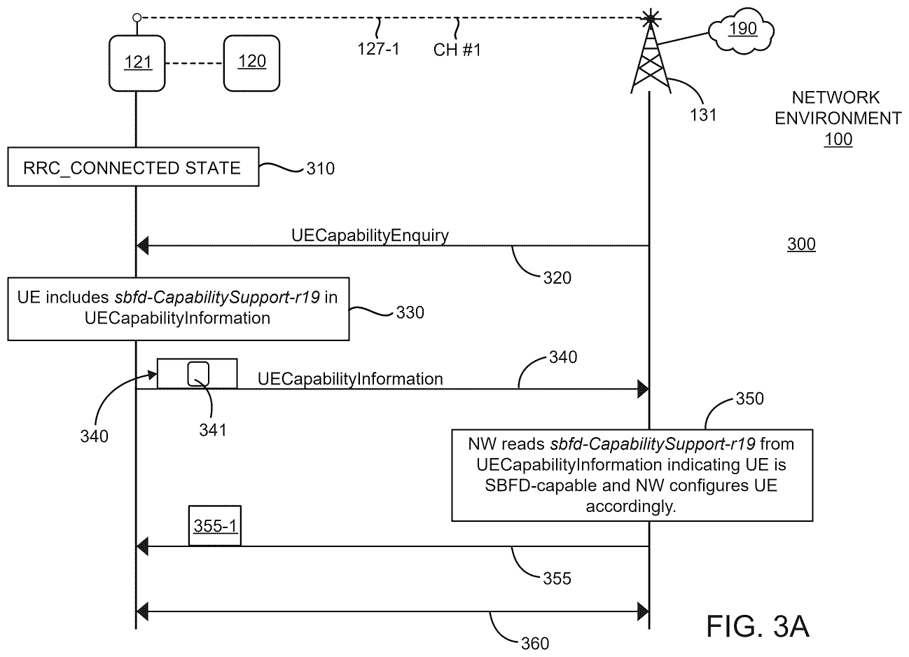

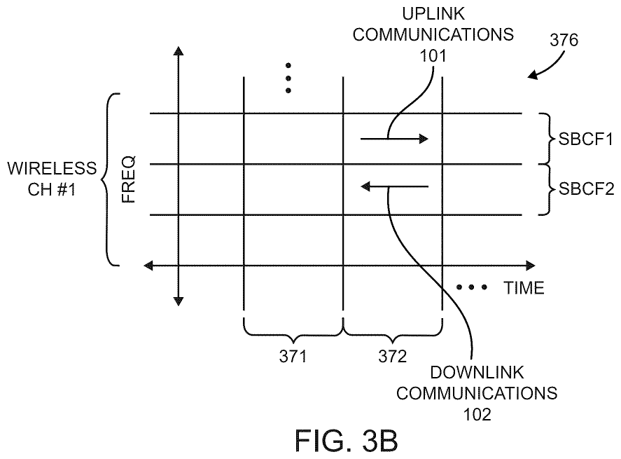

FIG. 3A is an example diagram illustrating conveyance of a capability inquiry and communication of capability information from a mobile communication device to a wireless access point as discussed herein.

In this example, the network environment 100 includes mobile communication device 121 already in communication (such as via RRC connected) with the wireless base station 131 over a corresponding wireless communication link 127-1. In one example, the mobile communication device 121 establishes the wireless communication link 127-1 (wireless connectivity) with the wireless base station 131.

Note that any of the resources as discussed herein can be configured as hardware, software, or a combination of hardware and software. For example, the mobile communication device 121 can be configured as or include a communication management resource implemented as communication management hardware, communication management software, or a combination of communication manager hardware and communication management software; wireless base station 131 can be configured as or include a communication management resource such as wireless base station hardware, wireless base station software, or a combination of wireless hardware and wireless base station software; wireless base station 131 can be configured as or include a communication management resource such as communication management hardware, communication management software, or a combination of communication management hardware and communication management software; and so on.

As shown in processing state 310, the mobile communication device (a.k.a., user equipment or communication management resource) is in an RRC (Radio Resource Control) connected state via the wireless communication link 127-1 between the mobile communication device 121 and the wireless base station 131 (such as wireless network or communication management resource).

While the mobile communication device 121 is in the RRC connected state, the wireless base station 131 transmits communications 320 over the wireless communication link 127-1 to the mobile communication device 121. In one example, the communications 320 include an inquiry regarding capabilities associated with the mobile communication device 121 as indicated by the configuration settings 120.

In such an instance, via the communications 320, the mobile communication device 121 receives an inquiry from the wireless base station 131. In one example, the inquiry in the communications 320 from the wireless base station 131 (such as an eNodeB, gNodeB, etc.) requests feedback from the communication device 121 of a communication configuration supported by the mobile communication device 121. In other words, via the communications 320, the wireless base station 131 generates a respective query to learn of a configuration of the mobile communication device 121 and what modes are supported by the mobile communication device 121.

In one example, the wireless base station 131 generates the communications 320 to learn whether or not the communication device 121 supports SBFD communications.

Further, in processing operation 330, the mobile communication device 121 accesses the corresponding configuration information 120 (such as store locally with respect to the communication device 121 or remotely with respect to the mobile communication device 121) to learn that the mobile communication device 121 supports sub-band full-duplex communication (SBFD) capabilities. In such an instance, the mobile communication device 121 produces a reply communication 340 in response to the received inquiry (communications 320).

In this example, the configuration information 120 indicates that the mobile communication device 121 (user equipment) supports the SBFD mode because the setting 185 is TRUE. For example, the reply communication 340 generated by the mobile communication device 121 can be configured to include a notification that the mobile communication device 121 operates in or at least supports a sub-band full-duplex SBFD operational mode.

As previously discussed, and as further discussed herein, the sub-band full-duplex operational mode is operative to support simultaneous conveyance of uplink and downlink communications over the wireless connectivity using multiple sub-carrier frequencies and in a respective time slot of an assigned wireless channel associated with the wireless communication link 127-1.

As further discussed below, one implementation of the sub-band full-duplex operational mode is a condition in which the mobile communication device is allocated a time slot and corresponding channel (bandwidth of multiple subcarrier frequencies) to simultaneously support bidirectional communications between the mobile communication device 121 and the wireless base station 131. The wireless base station 131 and mobile communication device 121 can be assigned use of wireless channel #1 to support communications associated with the wireless communication link 127-1. Further, the wireless base station 131 or other suitable entity can be configured to communicate schedule information over the wireless communication link 127-1 to the mobile communication device 121.

The schedule information can be configured to indicate one or more timeslots allocated for use by the mobile communication device 121 to simultaneously: i) receive downlink communications from the wireless base station 131 over the wireless communication link 127-1 to the mobile communication device 121 via first one or more subcarrier frequencies or sub-bands associated with allocated wireless channel #1, and ii) transmitted uplink communications from the mobile communication device 121 over the wireless communication link 127-1 to the wireless base station 131 via second one or more subcarrier frequencies or sub-bands associated with allocated wireless channel #1. Thus, as previously discussed, the allocated channel #1 or bandwidth allocated for use by the mobile communication device 121 may be divided into multiple sub-carrier frequencies to support the sub-band full-duplex operational mode in a particular time slot, where one or more first sub-carrier frequencies associated with the channel #1 is allocated and used in the particular time slot to support simultaneous bidirectional communications in an uplink direction between the mobile communication device 121 and the wireless base station 131 while one or more second subcarrier frequencies associated with the channel #1 is allocated and used in the particular time slot to support communications in a downlink direction between the wireless base station 131 and the mobile communication device 121.

With further reference to the flowchart 300 of FIG. 3A, in processing operation 330, in order to produce the reply 340 to the inquiry (communications 320), the mobile communication device 121 accesses and analyzes configuration information 120 associated with the mobile communication device 121, where the configuration information 120 in FIG. 1 indicates that the mobile communication device 121 is capable of operating in or configured to operate in the sub-band full-duplex operational mode.

In a further example, the reply (such as communications 340) generated by the mobile communication device 121 or other suitable entity can be configured to include a data field 341 (one or more data bits) reserved for indicating whether or not the mobile communication device 120 supports the sub-band full duplex operational mode. In response to detecting that the mobile communication device 121 supports the sub-band full-duplex operational mode as indicated by the configuration information 120 and corresponding data field 185 set to true, the mobile communication device 121 can be configured to modify a default value in the data field 341 and change it from the default value to a non-default value, where the nondefault value such as true indicates that the mobile communication device 121 supports the sub-band full-duplex SBFD operational mode.

As further shown, subsequent to generating the reply 340 in processing operation 330, and further in response to receiving the inquiry via communications 320, the mobile communication device 121 transmits the reply 340 to the wireless base station 131. Via a setting of the data field 341 in the reply 340 to a specific value such as true, the reply 340 indicates that the mobile communication device 121 is configured to operate in the sub-band full-duplex operational mode.

In yet further processing operation 350, the wireless base station 131 analyzes the received reply 340 and corresponding data field 341 to learn that the mobile communication device 121 supports sub-band full-duplex operational mode. Via subsequent communications 355, the wireless base station 131 communicates schedule information (such as including timing information and channel information) to the mobile communication device 121. The wireless base station 131 can be configured to transmit the communications 355 to the mobile communication device 121 in response to the mobile communication device 121 requesting allocation of channel resources subsequent to transmitting the communications 340 to the wireless base station 131.

Accordingly, at the mobile communication device 121, in response to transmitting the reply communications 340 to the wireless base station 131 indicating that the mobile communication device 121 supports the SBFD mode, and potentially after the mobile communication device 121 requests scheduling of wireless resources to convey data to or receive data from the wireless base station 131, the mobile communication device 121 receives a notification (such as communications 355 over the wireless communication link 127-1) from the wireless base station 131 indicating allocation of a wireless channel #1 supporting sub-band full-duplex communications.

In one example, the notification such as communications 355 can be configured to indicate a first time slot 372 and/or sub frequencies (see FIG. 3B) allocated for use by the mobile communication device 121, where the allocated first time slot 372 simultaneously supports uplink wireless communications from the mobile communication device 121 to the wireless base station 131 via one or more first subcarrier frequencies associated with the allocated wireless channel #1 and downlink wireless communications from the wireless base station 131 to the mobile communication device 121 via one or more second subcarrier frequencies associated with the allocated wireless channel #1. An example of the allocation is shown in FIG. 3B.

FIG. 3B is an example timing diagram illustrating implementation of multiple different subcarrier frequencies to support bidirectional communications in the SBFD mode as discussed herein.

As previously discussed, the allocated wireless channel #1 can be divided into multiple sub bands or subcarrier frequencies. In this example, the wireless channel #1 is partitioned into the first sub-wireless carrier frequency SBCF1, second sub-wireless carrier frequency SBCF2, etc., in the frequency domain. In accordance with a time division duplex configuration, the wireless channel and corresponding sub-wireless carrier frequencies are divided into multiple time slots including time slot 371, time slot 372, etc.

Referring again to a combination of FIGS. 3A and 3B, thus, in one example, the notification such as the communications 355 can be configured to indicate a first sub-wireless carrier frequency SBCF1 and a second sub-carrier wireless frequency SBCF2 associated with the allocated wireless #1, where the first sub-wireless carrier frequency SBCF1 is allocated for use by the mobile communication device 121 to transmit the uplink wireless communications (first data) from the mobile communication device 121 to the wireless base station 131, and where a second sub-wireless carrier frequency SBCF2 is allocated for use by the mobile communication device 121 to receive the downlink wireless communications (such as second data) over the wireless connectivity (127-1) from the wireless base station 131 in each of the multiple time slots 371, 372, etc.

As further shown, via a first portion of communications 360 (uplink communications in FIG. 3A), and via at least the first allocated sub-wireless carrier frequency SBCF1 associated with channel #1, the mobile communication device 121 transmits uplink wireless communications 101 from the mobile communication device 121 over the wireless connectivity (127-1) to the wireless base station 131 in the allocated time slot. Via a second portion of the communications 360 (downlink communications in FIG. 3B), and via at least the second sub-wireless carrier frequency SBCF2 associated with channel #1, the mobile communication device 121 receives the downlink wireless communications 102 from the wireless base station 131 over the wireless connectivity (127-1).

Thus, as shown in FIG. 3B, the sub-band full-duplex operational mode is operative to support simultaneous conveyance of uplink and downlink communications over the wireless connectivity using multiple sub-carrier frequencies of respective time slots 371, 372, etc., in an assigned wireless channel. For example the sub-band carrier frequency SBCF2 in timeslot 372 supports downlink communications from the wireless base station 131 to the mobile communication device 121. The sub-band carrier frequency SCBF1 in time slot 372 supports uplink communications from the mobile communication device 121 to the wireless base station 131.

Thus, in response to the mobile communication device 121 transmitting the reply 340 from the mobile communication device 121 over the wireless connectivity 127-1 to the wireless base station 131, and in response to the mobile communication device 121 requesting scheduling of wireless channel resources (i.e., timeslot, wireless channel #1, etc.) to simultaneously receive uplink communications while transmitting downlink communications in timeslot 372, the mobile communication device 121 receives schedule information 355-1 over the wireless connectivity (127-1) from the wireless base station 131 via communications 355. In one example of the schedule information 355-1 is generated by the wireless base station 131 or other suitable entity controlling scheduling of wireless communications being transmitted (uplink or downlink) in the network environment 100.

In one example, the schedule information 355-1 received in communications 355 from the wireless base station 131 indicates subsequent scheduled use of a wireless channel #1 by the mobile communication device 121 to support conveyance of data between the mobile communication device 121 and the wireless base station 131. As previously discussed, the schedule information 355-1 in communications 355 can be configured to indicate a schedule of the mobile communication device 121 and the wireless a station 131 supporting simultaneous bidirectional communications in a respective time slot 372 over different subcarrier frequencies of an allocated wireless bandwidth.

In accordance with further examples, the schedule information 355-1 in communications 355 can be configured to indicate that the mobile communication device 121 is allocated use of the wireless channel #1 during one or more timeslot such as including timeslot 371, timeslot 372, etc.

As previously discussed, the wireless channel #1 can be divvied up into multiple different sub-wireless band carrier frequencies, such as where the sub-wireless carrier frequency SBCF1 is allocated, as indicated by the schedule information 355-1, to support uplink communications 101 from the mobile communication device 121 to the wireless base station 131 in timeslot 372, and where the sub-wireless carrier frequency SBCF2 is allocated to support downlink communications 102 from the wireless base station 131 to the mobile communication device 121 in timeslot 372.

Accordingly, the notification (in communications 340) indicating that the mobile communication device 121 supports the SBFD communications results in allocation of the wireless channel and corresponding sub frequency bands to support the bidirectional communication between the mobile communication device 121 and the wireless base station 131.

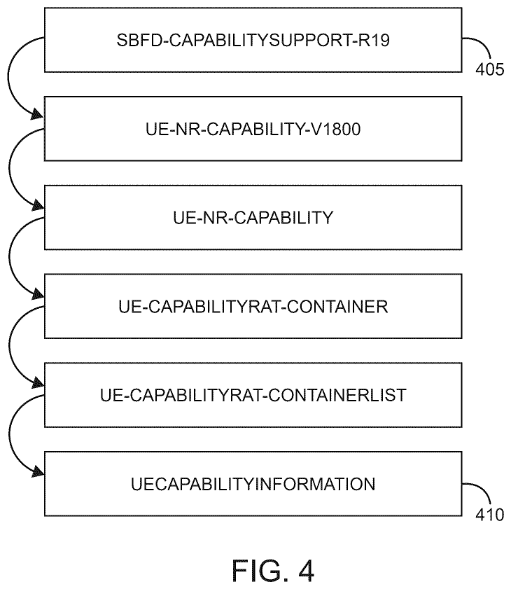

FIG. 4 is an example diagram illustrating encapsulation of sub full-duplex communication capability information associated with a mobile device as discussed herein.

In this example, when producing the communications 340, the mobile communication device 121 retrieves the configuration settings 405 from the configuration information 120, where the configuration settings 405 in this example indicate that the mobile communication device 121 supports the SBFD mode.

As further shown in FIG. 4, the mobile communication device 121 performs encapsulation operations using the retrieved configuration settings 405 to produce the user equipment capability information 410. The mobile communication device 121 is configured to include the user equipment capability information 410 (indicating that the mobile communication device 101 supports the SBFD mode) in the communications 340 as previously discussed in FIG. 3A.

It is noted that any suitable technique can be used to provide notification to the wireless base station 131 and corresponding wireless network that the mobile communication device 121 supports the SBFD mode.

Thus, an SBFD-aware UE can be configured to signal that it supports the SBFD mode to the wireless network (wireless base station 131) in response to communications 320 such as a UECapabilityEnquiry sent by the wireless base station 131 as follows:

If rat-Type in UE-CapabilityRAT-Container is set to nr:

If UE (a.k.a., mobile communication device 121) includes configuration information indicating sbfd-CapabilitySupport-r19=true (i.e., the mobile communication device 121 supports the SBFD mode), the mobile communication device 121 includes (or encapsulates) this IE value in the existing UE-NR-Capability-v1800 (or any corresponding 3GPP Release-19 UE-NR-Capability information container that may be defined in future) message as previously discussed in FIG. 3A, which may be signaled through RRC message UECapabilityInformation to the wireless base station as a response to the UECapabilityEnquiry RRC message.

Conversely, note that if the mobile communication device 121 does not support the SBFD communication mode option, then the corresponding user equipment (mobile communication device 121) does not signal this IE as part of UECapabilityInformation RRC message to the wireless base station 131. In such an instance, if the mobile communication device 121 never notifies the wireless base station 131 that it supports the SBFD mode, then the wireless base station 131 and corresponding communication management resource assume that the mobile communication device 121 is not SBFD capable. In such an instance, the wireless base station 131 prevents scheduling of SBFD resources to the mobile communication device 121. In other words, if the SBFD mode is not supported, the wireless base station 131 can be configured to allocate one or more sub frequency bands in timeslot 371 of the wireless channel #1 to support uplink communications from the mobile communication device 121 to the wireless base station 131; the wireless base station 131 may allocate one or more sub frequency bands in timeslot 372 of the wireless channel #1 to support downlink communications from the wireless base station 131 to the mobile communication device 121. Accordingly, in the non-SBS the mode, each timeslot supports only either uplink communications or downlink communications.

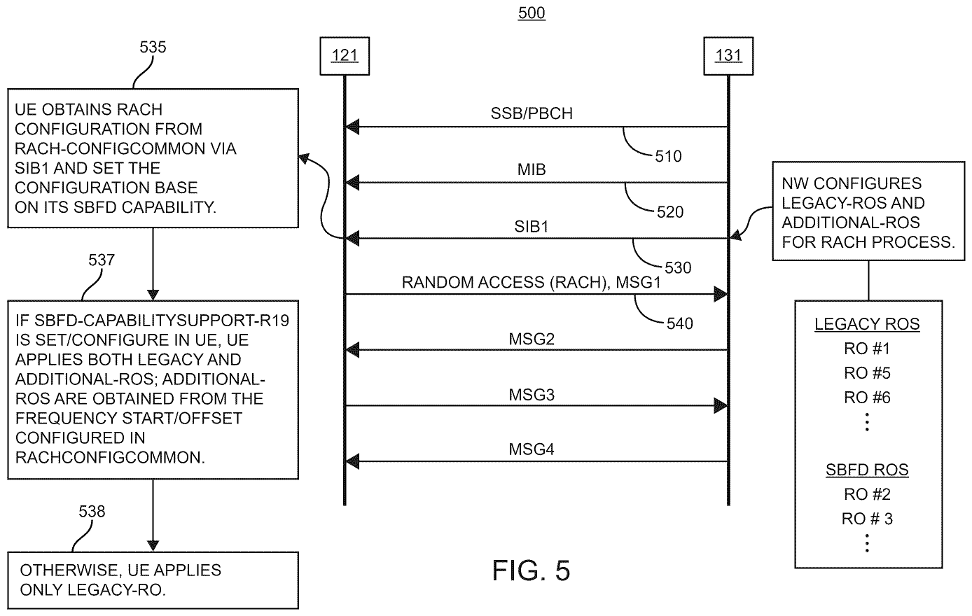

FIG. 5 is an example diagram illustrating distribution of channel access options to a mobile communication device and implementation of a channel access option via the mobile communication device as discussed herein.

In this example, assume that the mobile communication device 121 has not yet completed establishing wireless connectivity with the wireless base station 131. Different RACH occasions may be used by the mobile communication device 121 to provide notification to the wireless base station 131 whether or not the mobile communication device 121 would like to communicate using the SBFD communication mode. In general, as previously discussed, a so-called RACH (Random Access Channel) occasion is a specific time and frequency slot where a user equipment (UE) can send a preamble to the wireless base station 131 such as a 5G base station (gNB) to initiate a connection.

When the mobile communication device 121 desires to implement the SBFD mode, as previously discussed, different sub-carrier frequencies in a given time slot may be used in which the mobile communication device 121 simultaneously receives data from the wireless base station 131 and transmits data to the wireless base station 131.

In one example, during this initial access when the wireless base station 131 has no knowledge of the UE capability (SBFD) yet, the mobile communication device 121 can be configured to determine (read) supported RACH configurations (as indicated by the configuration information 120) to determine its capability. Assume that the mobile communication device 121 supports the SBFD communication mode.

As further shown in flow diagram 500, via communications 510, the wireless base station 131 and corresponding wireless network provide notification of system information associated with use of the wireless base station 131 and corresponding wireless network to the mobile communication device 121.

Via communications 520, the wireless base station 131 transmits a master information block message enabling the mobile communication device 121 to synchronize communications with the wireless base station 131.

In a further example, during the initial access, the wireless base station 131 may not be able to differentiate SBFD-aware UEs from non-SBFD UEs without receiving some sort of indication from the respective mobile communication devices. To address this issue, the wireless base station 131 can be configured to broadcast random access channel (RACH) resource information in a respective one or more SIB1 (System Information Block) message such as via communications 530.

In one example, the wireless base station 131 and corresponding wireless network configure the communications 530 to indicate multiple different channel access options such as a first channel access option supporting a non-SBFD mode (legacy) such as supported by all communication devices in the network environment and a second channel access option supporting a SBFD mode such as supported by newer communication devices such as including mobile communication device 121.

Via the communications 530, the mobile communication device 121 can be notified of two different types of ROs (RACH Occasions), namely, legacy-ROs (RACH occasions such as RO #1, RO #5, RO #6, etc., associated with channel access option #1 for non-SBFD mode communication devices) and additional-ROs (RACH occasions such as RO #2, RO #3, etc., associated with channel access option #2 for communication devices supporting the SBFD mode). Both of these different types of RACH occasions are available for use by the mobile communication device 121 to acquire channel resources (wireless channel, sub-carrier frequencies, timeslots, etc.) for conveyance of respective uplink and downlink data between the mobile communication device 121 and the wireless base station 131.

In one example, it is noted that the flow diagram 500 illustrates a 4 step RACH example in which the mobile communication device 121 is able to establish a respective wireless communication link 127-1 between the mobile communication device 121 and the wireless base station 131. In general, a 4-step RACH (Random Access CHannel) operation is a contention-based procedure used by User Equipment (UE) such as the mobile communication device 121 to establish an initial connection with a base station 131 (such as a so-called gNB). The process includes four main messages exchanged between the mobile communication device and the wireless base station 131: (MSG1) RACH Preamble, (MSG2) RACH Response, (MSG3) Connection Request, and (MSG4) Contention Resolution. The so-called “4-step” name associated with the RACH process is based on a multi-message exchange required to resolve potential contention when multiple UEs in the network environment 100 transmit at the same time to acquire a respective wireless channel to establish wireless connectivity with the wireless base station 131.

Thus, in this example, the SIB1 information transmitted in the communications 530 may indicate that both the first legacy-ROs (such as RO #1, RO #5, RO #6, etc.) and additional second-ROs (such as RO #2, RO #3, etc.), which may be configured in RACH-ConfigCommon. If the mobile communication device 121 supports SBFD operations (such as indicated where the configuration information 120 associated with the mobile communication device 131 indicates “sbfd-Capability Support-r19=true” or other suitable setting), the mobile communication device 121 receiving the communications 530 stores both legacy-ROs and additional-ROs for potential use during the RACH process. Basically, as previously discussed, the so-called RACH processes are used, potentially on and as needed basis, by the mobile communication device 121 and other communication devices to establish a respective wireless communication link to support respective uplink and downlink communications between the mobile communication device 121 and the wireless base station 131.

More specifically, in processing operation 535 and processing operation 537, to select an additional RO (RACH occasions supporting the establishment of a communication link supporting the SBFD mode) during initial access newly establishing the wireless communication link, the SBFD UE capability itself may be the trigger or precondition. That is, to read and apply additional-ROs (such as RO #2, RO #3, etc., indicating support of the SBFD mode) associated with the channel access information in the message 530, the mobile communication device 121 first checks the configuration information 120 (assigned to it) to determine if sbfd-Capability Support-r19=true (indicating that the mobile communication device 121 supports the SBFD mode). If so, the mobile communication device 121 obtains, from the channel access option #2 (supporting the SBFD mode), the corresponding frequency start and offset for those additional-ROs (such as RO #2, RO #3, etc. supporting SBFD) associated with the second channel access option to implement the SBFD capability when requesting scheduling of the wireless channel resources. In other words, the mobile communication device's use of a RACH occasion in the second channel access option (support notification of the SBFD mode) allocated to establish a communication link supporting SBFD notifies the wireless base station 131 that the mobile communication device 121 supports the SBFD mode.

Conversely, if the mobile communication device 121 does not support SBFD operations (i.e., in the absence of sbfd-Capability Support-r19 in the UE Capabilities information or the configuration information for SBFD where the communication setting 185 is set to false), the mobile communication device uses only the legacy-ROs (first channel access option) for RACH supporting establishment of a respective new wireless communication link.

In another example, in processing operation 538, if mobile communication device 121 implementation supports SBFD but the wireless base station 131 only supports legacy-ROs, the SBFD-aware mobile communication device 121 uses the legacy-ROs.

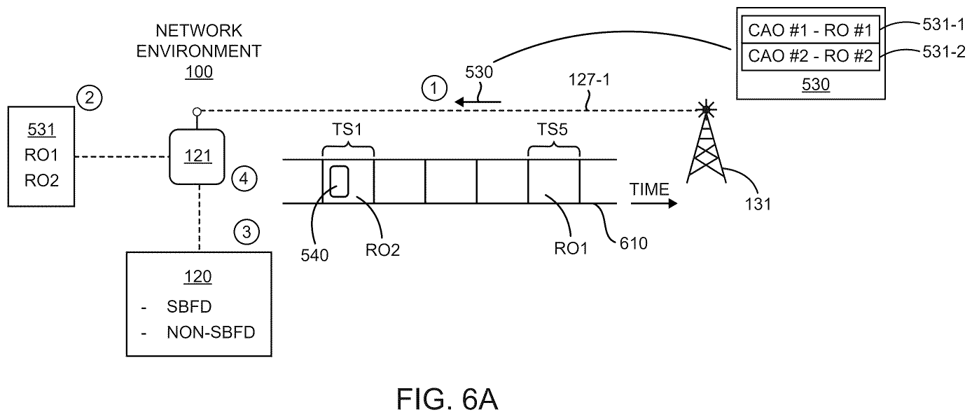

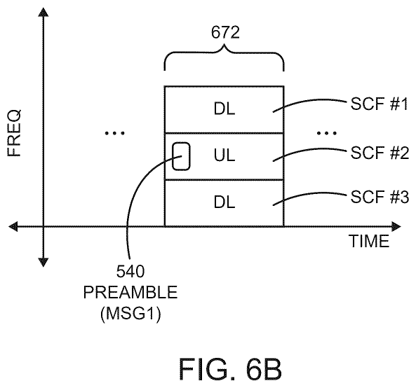

As further shown, in flow diagram 500 and corresponding processing operation 535, assume that the mobile communication device 121 learns from its configuration information 120 that it supports the SBFD mode. Further, assume that the mobile communication device 121 would like to be allocated use of wireless channel resources to support simultaneous conveyance of data between the mobile communication device 121 and the wireless base station 131 over different carrier frequencies and corresponding sub-bands. In such an instance, the mobile communication device 121 transmits a respective request via communications 540 using or in accordance with a second channel access option as indicated by the channel access option information. This may include the mobile communication device 121 sending a respective message MSG1 over the random-access channel from the mobile communication device 121 to the wireless base station 131 using the RACH occasion supporting the SBFD communication mode. In other words, when the mobile communication device 121 responds by sending (such as in communications 540) an appropriate preamble in a RACH occasion dedicated to provide the notification of the selected SBFD communication mode, this sending of the preamble in the RACH occasion RO #2, RO #3, etc., notifies the wireless base station 131 that the mobile communication device 121 supports or would like to use the SBFD communication mode. Additional details of using the second channel access option of acquiring wireless connectivity resources to establish the wireless communication link 127-1 are discussed in the following FIGS. 6A and 6B.

FIG. 6A is an example diagram illustrating distribution of channel access option information to a mobile communication device and implementation of a selected channel access option by the mobile communication device as discussed herein.

In this example, as previously discussed, via communications 530, the wireless base station 131 provides notification of the different channel access options (channel access option #1 supporting first RACH occasions associated with the non-SBFD communication mode and channel access option #2 supporting second RACH occasions associated with the SBFD communication mode) supported by the corresponding random-access channel 610, where different RACH occasions in the random-access channel 610 are shared amongst multiple different mobile communication devices to acquire connectivity with the wireless base station 131 and obtain scheduling of wireless resources for communications.

Further in this example, the first channel access option information 531-1 can be configured to indicate timing of at least one RACH (Random Access Channel) occasion such as RACH occasion RO1 in the shared random-access channel 610, where the corresponding first channel access option #1 and corresponding occasion RO1 (timeslot) supports notification and selection of the non-sub-band full-duplex communications by the mobile communication device 121; the second channel access option information 531-2 can be configured to indicate timing of at least one RACH (Random Access Channel) occasion RO2 in the random-access channel 610, where the second channel access option #2 and corresponding RACH occasion RO2 supports notification and selection of the sub-band full-duplex communications.

Accordingly, the first channel access option (RO1) as indicated by the channel access information 531-1 may be available for establishing the wireless connectivity via use of non-sub-band full-duplex communications between the mobile communication device and the wireless base station; the second channel access option (RO2) as indicated by the channel access information 531-2 may be available for establishing the wireless connectivity via use of sub-band full-duplex communications between the mobile communication device in the wireless base station.

As previously discussed, the RACH occasions for the different channel access options indicate the specific different timing in the random-access channel 610 in which the corresponding communication devices in the network environment 100 are to transmit a respective communication link establishment request message (such as message 1 or MSG1 including a corresponding preamble).

In other words, if the mobile communication device 121 wishes to select and use the non-SBFD communication option, the mobile communication device 121 transmits a respective resource scheduling request (such as communications 540) using the RACH occasions (timeslot RO1) associated with the channel access option #1 of the shared channel 610 supporting the non-SBFD communications.

On the other hand, in this example, the mobile communication device 121 is configured to support the SBFD mode. In response to the mobile communication device 121 wishing to use the SBFD communication option, the mobile communication device 121 transmits a respective resource scheduling request (such as message #1 in a multi-step RACH process) request using the RACH occasion RO2 associated with the channel access option #2. Receipt of the request by the wireless base station 131 in the different RACH occasions indicates whether the mobile communication device 121 supports the SBFD mode. For example, in response to the communication device 121 transmitting the request for wireless resources in the RACH occasion RO2 in this example, the wireless base station 131 receives the request such as a preamble in the RACH occasion RO2 and thus knows that the mobile communication device 121 is requesting resources supporting the SBFD mode.

Thus, in processing operation #1 as shown in FIG. 6A, via communications 530, the mobile communication device 121 receives channel access information 531 from the wireless base station 131. As previously discussed, the channel access information 531 includes channel access information 531-1 such as channel access option #1 specifying first RACH occasions (including RACH occasion RO1) and channel access information 531-2 such as channel access option #2 specifying second RACH occasions (such as including RACH occasion RO2). The RACH occasions in either case support establishment of wireless connectivity and request of wireless resources to convey communications between the mobile communication device 121 and the wireless base station 131 via the multiple different channel access options.

In processing operation #2, the mobile communication device 121 can be configured to store the channel access information 531 such as including channel access information 531-1 indicating RACH occasion RO1 and channel access information by 531-2 indicating RACH occasion RO2 for later use.

In a further example, processing operation #2 further includes the mobile communication device 121 retrieving the channel access information 531. Based on the retrieved channel access information 531, the mobile communication device 121 determines which RACH occasion RO1 or RO2 is to be selected and used to support the different wireless resource scheduling modes to communicate between the mobile communication device 121 and the wireless base station 131.

As further shown, in processing operation #3, the mobile communication device 121 determines a configuration of the mobile communication device 121 via analysis of the configuration information 120. As previously discussed, the configuration information 120 may indicate the different modes supported by the mobile communication device 121.

In this example, assume that the configuration information 120 assigned to the mobile communication device 121 indicates that the mobile communication device 121 supports both the non-SBFD and the SBFD mode. In such an instance, the mobile communication device 121 may select from any of the different available communication options (RACH occasions) depending upon which of the communication modes (non-SBFD and the SBFD mode) is desired for use by the mobile communication device 121.

It is noted again that the non-SBFD communication mode supports only one way (uplink or downlink) communications between the mobile communication device 121 and the wireless base station 131 during a respective assigned one or more timeslots. However, as previously discussed, the SBFD communication mode supports simultaneous bidirectional (uplink and the downlink using different subcarrier frequencies of the assigned wireless channel) communications between the mobile communication device 121 and the wireless base station 131 during each respective assigned one or more timeslots.

Accordingly, there may be instances in which the mobile communication device 121 may wish to request scheduling of one way communications (such as non-SBFD communications) in a time slot or request scheduling of bidirectional communications (such as SBFD communications) in a time slot. As further discussed herein, this is achieved by selecting and using the appropriate RACH occasions as indicated by the different channel access options defined by communications 530.

Note that the mobile communication device 121 can be configured to receive priority information from any suitable entity, where the priority information indicates which of the multiple different channel access options is desired for implementation by the mobile communication device 121 at a particular time. In other words, the mobile communication device 121 can be configured to request operation of supporting conveyance of SBFD communications for a first duration of time while the mobile communication device 121 can be configured to request operation supporting conveyance of non-SBFD communications for a second duration of time.

Assume in this case that the mobile communication device 121 selects the RACH occasion RO #2 (a.k.a., RO2) because the mobile communication device 121 would like to operate in the so-called SBFD mode. In other words, further in this example, based on the determined configuration indicating that the mobile communication device 121 supports the SBFD communications in processing operation #3, assume that the mobile communication device 121 wishes to implement the SBFD mode. In such an instance, the mobile communication device 121 selects a RACH occasion (such as RACH occasion RO2) from the second channel access option (channel access information 531-2) amongst the multiple channel access options 531 as indicated by the communications 530 and corresponding channel access information to establish the wireless connectivity between the mobile communication device and the wireless base station.

As previously discussed, the channel access information 531-2 can be configured to indicate timing and respective time slot (occasion) associated with transmitting a respective channel access request in the random-access channel 610. In other words, the mobile communication device 121 synchronizes itself with respect to the wireless base station 131. The synchronization enables the mobile communication device 121 to communicate over the random-access channel 610 in the appropriate different timeslots (RACH occasions) to communicate a respective request to the wireless base station 131 for allocation of wireless channel resources supporting conveyance of data communications.

Further, the channel access information 531-2 indicates to transmit in the RACH occasion RO2 (specific time slot or occasion in the random-access channel 610) during conditions in which the mobile communication device 121 would like to be allocated wireless channel resources to support the SBFD mode. Conversely, the channel access information 531-1 indicates to transmit a respective wireless channel request in the RACH occasion RO1 (specific time slot in the random-access channel 610) during conditions in which the mobile communication device 121 would like to be allocated wireless channel resource to support the non-SBFD mode.

Further in this example, because the mobile communication device 121 decides to request use of SBFD mode, in processing operation #4, the mobile communication device 121 transmits a respective communication 540 such as preamble (such as message #1) in the RACH occasion RO2 supporting the request for wireless resources associated with the SBFD communication mode. Thus, in accordance with timing as specified by the second channel access option and corresponding RACH occasion RO2, the mobile communication device 121 transmits communications 540 from the mobile communication device 121 to the wireless base station to establish the wireless connectivity 127-1 and/or request scheduling of wireless resources to convey data.

As previously discussed, the communications 540 may be or include a message #1 (MSG1) associated with a multi-step RACH (Random Access Channel) as previously discussed.

Accordingly, the communications 540 transmitted from the mobile communication device 121 in the RACH occasion RO2 (timeslot TS1) of the random-access channel 610 may include a preamble transmitted in a RACH occasion RO2 as indicated by the second channel access option, where the preamble is transmitted from the mobile communication device 121 in the RACH occasion RO2 for subsequent scheduling/allocation of communications between the mobile communication device and the wireless base station.

Transmission of the preamble message (such as communications 540) in the RACH occasion RO2 of the random-access channel 610 in accordance with the timing and frequency as specified by the channel access information 531-2 supports subsequent scheduling of communications between the mobile communication device and the wireless base station via sub-band full-duplex communications.

In other words, as previously discussed, the communications 540 may be a first message (MSG1) in a multistep RACH process (such as 2-step or 4-step RACH process). Via further messages from the wireless base station 131 to the mobile communication device 121, the wireless base station 131 provides notification of the allocation of wireless channel resources to support the data conveyance request.

Thus, it is noted that the configuration information 120 assigned to the mobile communication device 121 may indicate that the mobile communication device is configured to use any of the different modes such as the non-SBFD mode or the SBFD mode. It is also noted that the channel access option #1 as indicated by the channel access information 531-1 may be a fallback with respect to the channel access option #2 during a condition in which the channel access option #2 and the SBFD communication mode is unavailable. Alternatively, the channel access option #2 as indicated by the channel access information 531-2 may be a fallback with respect to the channel access option #1 during a condition in which the channel access option #1 is unavailable.

Additionally, the channel access option #2 as indicated by the channel access information 531-2 may be simultaneously available when the channel access option #1 is available.

FIG. 6B is an example diagram illustrating allocation of resources to support SBFD communications as discussed herein.

For example, as previously discussed, the mobile communication device 121 transmits the preamble (communications 540) in the uplink during the RACH occasion RO2 to request scheduling of simultaneous uplink and downlink communications between the mobile communication device 121 and the wireless base station 131. This example assumes that the mobile communication device 121 is granted wireless channel resources. In such an instance, the appropriate wireless channel resources are assigned to support conveyance of data between the mobile communication device 121 and the wireless base station 131 during the time slot 672.

For example, the subcarrier frequency SCF #1 supports downlink communications from the wireless base station 131 to the mobile communication device 121; the subcarrier frequency SCF #2 supports uplink communications (such as including the preamble or communications 540) from the mobile communication device 121 to the wireless base station 131; the subcarrier frequency SCF #3 supports downlink communications from the wireless base station 131 to the mobile communication device 121.

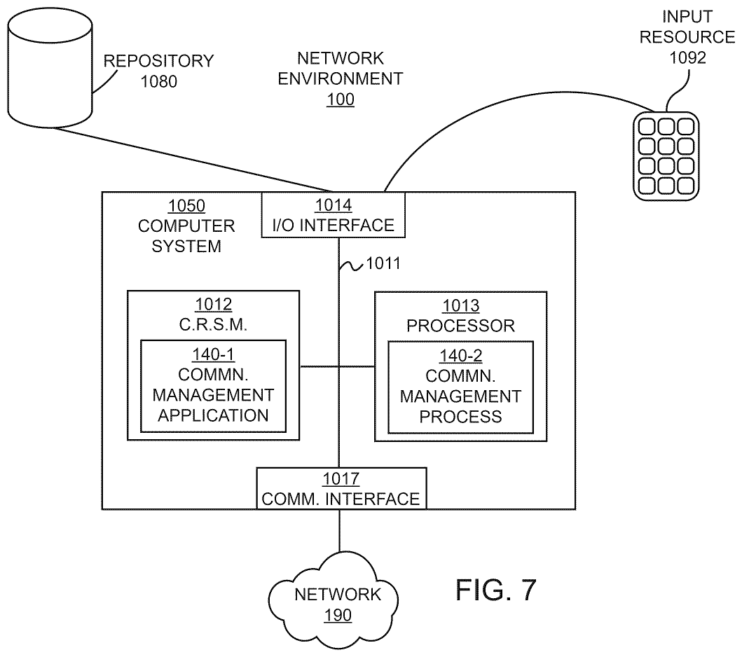

FIG. 7 is an example block diagram of a computer system for implementing any of the operations as previously discussed according to examples herein.

Note that any of the resources (such as allocation mobile communication device 121, wireless base nation 131, etc.) as discussed herein can be configured to include computer processor hardware and/or corresponding executable instructions to carry out the different operations as discussed herein.

For example, as shown, computer system 1050 of the present example includes interconnect 1011 coupling computer readable storage media 1012 such as a non-transitory type of media or computer readable storage hardware (which can be any suitable type of resource in which digital information can be stored and or retrieved), a processor 1013 (computer processor hardware), I/O interface 1014, and a communications interface 1017.

I/O interface(s) 1014 supports connectivity to repository 1080 and input resource 1092.

Computer readable storage medium 1012 can be any hardware storage device such as memory, optical storage, hard drive, floppy disk, etc. In one example, the computer readable storage medium 1012 stores instructions and/or data.

As shown, computer readable storage media 1012 can be encoded with communication management application 140-1 in a respective one or more network nodes to carry out any of the operations as discussed herein.

During operation of one example, processor 1013 accesses computer readable storage media 1012 via the use of interconnect 1011 in order to launch, run, execute, interpret or otherwise perform the instructions in management application 140-1 stored on computer readable storage medium 1012. Execution of the management application 140-1 produces management process 140-2 to carry out any of the operations and/or processes as discussed herein.

Those skilled in the art will understand that the computer system 1050 can include other processes and/or software and hardware components, such as an operating system that controls allocation and use of hardware resources to execute the management application 140-1.

In accordance with different examples, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1050 may reside at any location or can be included in any suitable resource in any network environment to implement functionality as discussed herein.

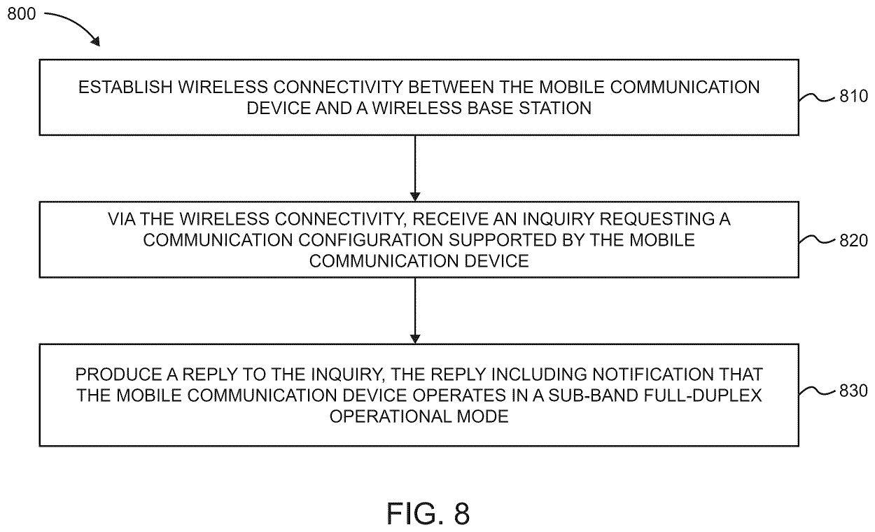

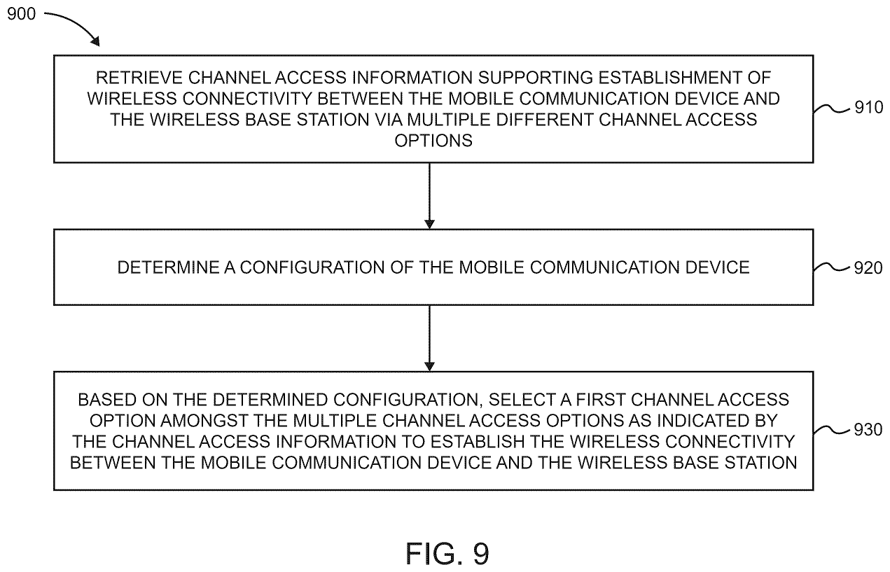

Functionality supported by the different resources will now be discussed via flowchart 800 in FIG. 8 and flowchart 900 in FIG. 9. Note that the steps in the flowcharts below can be executed in any suitable order.

FIG. 8 is a flowchart 800 illustrating an example method according to examples herein. Note that there will be some overlap with respect to concepts as discussed above.

In processing operation 810, the mobile communication device 121 establishes wireless connectivity between the mobile communication device and a wireless base station.

In processing operation 820, via the wireless connectivity, the mobile communication device receives an inquiry requesting a communication configuration supported by the mobile communication device.

In processing operation 830, the mobile communication device 121 produces a reply to the inquiry, where the reply includes notification that the mobile communication device operates in a sub-band full-duplex operational mode.

FIG. 9 is a flowchart 900 illustrating an example method according to examples herein. Note that there will be some overlap with respect to concepts as discussed above.

In processing operation 910, the mobile communication device receives channel access information from a wireless base station, where the channel access information supports establishment of wireless connectivity or scheduling of wireless resources to support communications between the mobile communication device and the wireless base station via multiple different channel access options.

In processing operation 920, the mobile communication device determines a configuration of the mobile communication device.

In processing operation 930, based on the determined configuration, selects a first channel access option amongst the multiple channel access options as indicated by the channel access information to establish the wireless connectivity between the mobile communication device and the wireless base station.

Note again that techniques herein are well suited to support providing notification of user equipment supported capabilities to a wireless network such as a wireless base station. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical, electronic, or magnetic quantities within memories, registers, or other information storage devices, transmission devices, or display devices of the computing platform.

While this example has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

1. A method comprising:
via a mobile communication device:
establishing wireless connectivity between the mobile communication device and a wireless base station;
via the wireless connectivity, receiving an inquiry requesting a communication configuration supported by the mobile communication device; and
producing a reply to the inquiry, the reply including notification that the mobile communication device operates in a sub-band full-duplex operational mode.

2. The method as in claim 1, wherein the sub-band full-duplex operational mode is operative to support simultaneous conveyance of uplink and downlink communications over the wireless connectivity using multiple sub-carrier frequencies of an assigned wireless channel; and
wherein producing the reply to the inquiry includes the mobile communication device accessing configuration information associated with the mobile communication device, the configuration information indicating that the mobile communication device operates in the sub-band full-duplex operational mode.

3. The method as in claim 1, wherein the reply includes a data field; and
wherein producing the reply includes: in response to detecting that the mobile communication device supports the sub-band full-duplex operational mode, modifying a default value in the data field to a non-default value, the non-default value indicating that the mobile communication device supports the sub-band full-duplex operational mode.

4. The method as in claim 1 further comprising:
in response to receiving the inquiry, wirelessly transmitting the reply to the wireless base station, the reply indicating that the mobile communication device is configured to operate in the sub-band full-duplex operational mode.

5. The method as in claim 4 further comprising:
at the mobile communication device, in response to wirelessly transmitting the reply to the wireless base station, receiving a notification from the wireless base station indicating allocation of a wireless channel supporting sub-band full-duplex communications.

6. The method as in claim 5, wherein the notification received from the wireless base station indicates a first time slot allocated for use by the mobile communication device, the allocated first time slot supporting uplink wireless communications from the mobile communication device to the wireless base station and downlink wireless communications from the wireless base station to the mobile communication device over the wireless channel.

7. The method as in claim 6, wherein the notification further indicates a first sub-wireless carrier frequency and a second sub-wireless carrier frequency in the wireless channel;
wherein the first sub-wireless carrier frequency is allocated for use by the mobile communication device to transmit the uplink wireless communications over the wireless connectivity from the mobile communication device to the wireless base station; and
wherein the second sub-wireless carrier frequencies is allocated for use by the mobile communication device to receive the downlink wireless communications over the wireless connectivity from the wireless base station.

8. The method as in claim 7 further comprising:
via the first sub-wireless carrier frequency, transmitting the uplink wireless communications from the mobile communication device over the wireless connectivity to the wireless base station in the allocated time slot; and
via the second sub-wireless carrier frequency, that the mobile communication device, receiving the downlink wireless communications from the wireless base station over the wireless connectivity in the allocated time slot.

9. The method as in claim 1 further comprising:
receiving the inquiry at the mobile communication device during a condition in which the mobile communication device operates in an RRC (Radio Resource Control) connected state.

10. The method as in claim 1 further comprising:
in response to the mobile communication device transmitting the reply from the mobile communication device over the wireless connectivity to the wireless base station, receiving schedule information over the wireless connectivity from the wireless base station, the schedule information indicating scheduled use of a wireless channel by the mobile communication device, the scheduled use supporting simultaneous uplink and downlink communications over the wireless connectivity.

11. A system comprising:
a mobile communication device operative to:
establish wireless connectivity between the mobile communication device and a wireless base station;
via the wireless connectivity, receive an inquiry requesting a communication configuration supported by the mobile communication device; and
produce a reply to the inquiry, the reply including notification that the mobile communication device operates in a sub-band full-duplex operational mode.

12. The system as in claim 11, wherein the sub-band full-duplex operational mode is operative to support simultaneous conveyance of uplink and downlink communications over the wireless connectivity using multiple sub-carrier frequencies of an assigned wireless channel; and
wherein the mobile communication device is further operative to produce access configuration notification associated with the mobile communication device, the excess configuration notification indicating that the mobile communication device operates in the sub-band full-duplex operational mode.

13. The system as in claim 11, wherein the reply includes a data field; and
wherein the mobile communication device is further operative to: in response to detecting that the mobile communication device supports the sub-band full-duplex operational mode, modify a default value in the data field to a non-default value, the non-default value indicating that the mobile communication device supports the sub-band full-duplex operational mode.

14. The system as in claim 11, wherein the mobile communication device is further operative to:
in response to receiving the inquiry, wirelessly transmit the reply to the wireless base station, the reply indicating that the mobile communication device is configured to operate in the sub-band full-duplex operational mode.

15. The system as in claim 14, wherein the mobile communication device is further operative to:
at the mobile communication device, in response to transmitting the reply to the wireless base station, receive a notification from the wireless base station indicating allocation of a wireless channel supporting sub-band full-duplex communications.

16. The system as in claim 15, wherein the notification received from the wireless base station indicates a first time slot allocated for use by the mobile communication device, the allocated first time slot supporting uplink wireless communications from the mobile communication device to the wireless base station and downlink wireless communications from the wireless base station to the mobile communication device.

17. The system as in claim 16, wherein the notification further indicates a first sub-wireless carrier frequency and a second sub-wireless carrier frequency in the wireless channel;
wherein the first sub-wireless carrier frequency is allocated for use by the mobile communication device to transmit the uplink wireless communications from the mobile communication device to the wireless base station; and
wherein the second sub-wireless carrier frequencies is allocated for use by the mobile communication device to receive the downlink wireless communications over the wireless connectivity from the wireless base station.

18. The system as in claim 17 further comprising:
via the first sub-wireless carrier frequency, transmitting the uplink wireless communications from the mobile communication device over the wireless connectivity to the wireless base station in the allocated time slot; and
via the second sub-wireless carrier frequency, receiving the downlink wireless communications from the wireless base station from the wireless base station over the wireless connectivity in the allocated time slot.

19. The system as in claim 11, wherein the mobile communication device is further operative to:
receive the inquiry at the mobile communication device during a condition in which the mobile communication device operates in an RRC (Radio Resource Control) connected state.

20. The system as in claim 11, wherein the mobile communication device is further operative to:
in response to the mobile communication device wirelessly transmitting the reply from the mobile communication device over the wireless connectivity to the wireless base station, receive schedule information over the wireless connectivity from the wireless base station, the schedule information indicating scheduled use of a wireless channel by the mobile communication device, the scheduled use supporting simultaneous uplink and downlink communications over the wireless connectivity.

21. Computer-readable storage hardware having instructions stored thereon, the instructions, when carried out by computer processor hardware, cause the computer processor hardware to:
establish wireless connectivity between the mobile communication device and a wireless base station;
via the wireless connectivity, receive an inquiry requesting a communication configuration supported by the mobile communication device;
and produce a reply to the inquiry, the reply including notification that the mobile communication device operates in a sub-band full-duplex operational mode.

22-38. (canceled)
